(19) United States
(12) Patent Application Publication
(10) Pub. No.: US 2018/0372445 A1
(43) Pub. Date: Dec. 27, 2018

(54) GUN VIDEO CAMERA SYSTEM

(71) Applicant: Check 6 Tactical & Training, LLC, Franklinton, NC (US)

(72) Inventors: Jason W. Myers, Franklinton, NC (US); Robert M. Christensen, Stuart, FL (US)

(73) Assignee: Check 6 Tactical & Training, LLC, Franklinton, NC (US)

(21) Appl. No.: 16/052,079

(22) Filed: Aug. 1, 2018

Related U.S. Application Data
(63) Continuation-in-part of application No. 15/425,309, filed on Feb. 6, 2017, now abandoned.

(51) Int. Cl. F41C 27/00; F41A 17/06; F41A 19/11; F41C 33/02; G03B 29/00; H04N 5/225; H04N 5/77

(52) U.S. Cl. CPC F41C 27/00; F41A 17/06; F41A 19/11; F41C 33/0254; F41G 11/003; G03B 29/00; H04N 5/2257; H04N 5/77; F41C 33/029

(57) ABSTRACT

The invention is a tamper evident camera positioned on a gun, for example, mounted on the Weaver/Picatinny rail.

This application is a continuation-in-part of U.S. non-provisional application Ser. No. 15/425,309 filed on Feb. 6, 2017 and is incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a camera system for use on a gun. In particular, it relates to a tamper evident video camera system designed to be mounted on a gun such as a hand gun.

### Description of Related Art

The use of a gun in law enforcement is essentially universal to assist an officer in their duties as well as protect the officer from potential injury or death. The presence of a gun means from time to time the gun will be utilized with a suspect and that interaction can result in the suspect's injury or death. It has become increasingly of concern by the public that the use of a gun in such situations are not in keeping with the proper rights and safety of suspects and increased scrutiny of such situations has increasingly occurred. The use of body cams in some instances has attempted to provide evidence of such interactions but the need to constantly record has left issues such as battery operation length of an all-day video and the problem that a body cam is only as good as where the officer's body is pointed and that's not always where a gun is pointed. In addition, watch groups feel that some unscrupulous officers are tampering with the video footage as well as the camera and accordingly such video evidence is suspect, and in some cases non-existent.

The thought that a video camera could be attached to a gun means that the camera records what the gun sees regardless of what happens to the officer. Such cameras attached to a gun have been around since at least 1936 and some grab both the top and bottom of the trigger guard, but the current camera configurations have serious problems in addressing the fundamental situation. If just a camera is mounted on the gun, nothing prevents the tampering of the camera. The video can be easily erased. The camera might have an on/off switch, but that can be forgotten about or turned off inappropriately. The camera needs to point where the gun points but in the heat of interacting with a suspect, the camera can get misaligned even with something as simple as drawing the gun from its holster.

### BRIEF SUMMARY OF THE INVENTION

The present invention relates to use of a Hall effect sensor or a magnetic reed switch in the camera on a gun which is magnetically triggered on removal of the gun from the holster wherein the camera has wing constraints that are positioned on either side of the front of the trigger guard to prevent movement of the camera. In some embodiments, it is designed such that the officer cannot tamper with the camera by providing tamper evident features.

Accordingly, in one embodiment, there is a use of a self-contained tamper evident video camera system for use on a tactical gun with a trigger guard having a front, bottom, and back and stored in a tactical holster wherein the gun is designed for use in tactical situations, the self-contained video camera system consisting of:
a) a video camera;
b) a mounting bracket which removably attaches the video camera system to the tactical gun;
c) a single on and off switch for the camera consisting of a Hall effect sensor or a magnetic reed switch in the video camera system and a magnet on the holster;
d) a battery to power the video camera;
e) a recordable medium in the self-contained video camera system for recording video wherein a recorded video on the recordable medium can be accessed by at least one of the group consisting of a video download port and a wireless transmitter;
f) wherein the video camera, the switch, the battery, the wireless transmitter, and the recordable medium are contained in a tamper evident case, which is constructed to be positioned with wing constraints at the rear of the case which are positioned on either side of only the front of the trigger guard and positioned against the trigger guard to brace the housing from moving left or right; and
g) wherein the video camera system has at least one feature selected from the group consisting of a microcontroller, a light guide, a light, a gauss strength measuring device, a power output, a charging port, a system that prevents firing of the gun unless the camera is operating, encryption software, and night vision for the camera.

### BRIEF DESCRIPTION OF THE DRAWINGS

FIG. 1 is a side perspective of the invention.

FIG. 2 is a perspective view of the invention.

FIG. 3 is a different perspective view of the camera system.

FIG. 4 is a side view of the system with the gun on a holster.

### DETAILED DESCRIPTION OF THE INVENTION

While this invention is susceptible to embodiment in many different forms, there is shown in the drawings and will herein be described in detail specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term “comprising” could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps or acts are in some way inherently mutually exclusive.

The drawings featured in the figures are for the purpose of illustrating certain convenient embodiments of the present invention and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “video camera system” refers to a digital video camera designed for attachment to a tactical gun used by an officer having a Weaver/Picatinny rail below the barrel on the tactical gun. The camera system is designed to be tamper evident to make it difficult for the officer to tamper with the starting and stopping of the video as well as the recording process itself without evidence. This is done in order to protect the integrity of any evidence being collected by the camera and prevent an officer from turning the camera off when their gun is in use. The video camera will have a battery to power the device and in some embodiments, can have a charging port and a video download port. In some embodiments, such ports are designed to not be accessible by the officer and require seal breaking, specialized tools, specialized screws, and the like so such activities are difficult for the officer to perform and thus done back at the station or headquarters after an event where the gun is utilized. In one embodiment, the camera includes audio recording.

As used herein, the term “tactical gun or gun” refers to a gun used preemptively, defensively, or operationally in a tactical situation, state, or setting, and the like, where benefit can be attained by recording the activity from the gun frontal view. Most all guns can be converted and/or applied as a tactical gun.

As used herein, the term “full trigger guard” refers to a protective guard that surrounds the trigger, as shown in the Figures. Such trigger guards are standard and well known within the trade. They have a front, a bottom portion, and a back portion. The wings of the present invention are only positioned on either side of the front of the trigger guard, and not the bottom or back, to prevent interference with the trigger. They are positioned to prevent the camera from moving left or right.

As used herein, the term “tactical holster” refers to a holster that is designed to receive a tactical gun, particularly ones, in one embodiment, that are designed to have a flashlight mounted on the Weaver/Picatinny rail since the camera of the present invention is designed of roughly similar dimensions to be able to fit into such tactical holsters. In one embodiment, it is any device that holds the gun.

As used herein, the term “tactical situations” refers to a situation where an officer draws his tactical gun from its holster where the gun might be utilized.

As used herein, the term “video camera” refers to a digital camera having a lens design to record to a memory device while the gun is in use or activated.

As used herein, the term “tamper evident case” refers to a case for enclosing the camera that will show evidence of being opened or attempt to open, and interference or forced malfunction by anyone with physical access to the camera, Hall effect sensor or a magnetic reed switch, memory device, optional microcontroller, and transmitter constructed in such a way that entry is difficult without leaving traces of such entry such as seals, break off screws, odd design screws, color change strips, required specialized tools, and the like. In one embodiment, it is sufficiently difficult to open the case to access the memory or camera, and the officer cannot do so in the field and must return to headquarters, or the like, for any service or downloading of the information contained therein. One tamper feature is the camera only has one way to turn on/off.

As used herein, the term “mounting bracket” refers to a mounting bracket positioned on the top of the tamper evident case designed for removably attaching the camera system to the Weaver/Picatinny rail of the gun. In one embodiment, or other embodiments, it can employ any attachment method including clamping, screwing, and the like for attachment to long or short barreled firearms.

As used herein, the term “mechanism for automatically turning the camera on” refers to a device in the system such that the camera is turned on when the gun is removed from the holster and turns off when the gun is returned to the holster. The device as the only way to turn the camera on or off can be any mechanical or electronic means such as infrared, wireless, mechanical switch, or the like. In one embodiment, the device is a Hall effect sensor or a magnetic reed switch positioning the camera with a magnet positioned in the holster such that removing the gun causes the magnet to pass the Hall effect sensor or a magnetic reed switch which turns it on and the reverse when the gun is placed back in the holster. Since the camera is positioned in front of the trigger guard and wings are on either side of the front of the trigger guard, positioning the magnet or other device in the appropriate area of the holster, it is within the skill in the art in view of the disclosure herein.

As used herein, the term “battery” refers to a DC source to power the camera's memory device for recording any microcontroller or other device detection associated with the camera system, like a Wi-Fi or Bluetooth, cellular communications module, or the like, for sending the recording to a location different from the location of the gun. In one embodiment, sending is automatic.

As used herein, the term “memory device” refers to a recordable memory and a recording device to take the image/video from the camera and record it on a recordable medium like a non-volatile memory card (e.g., multimedia cards, secure digital cards, data storage cards, etc.) or the like.

As used herein, the term “wing constraints at the rear of the case” refers to the housing of the system having a left and right wing being dovetail positioned at the rear of the case which are positioned on either side of only the front of the trigger guard, as shown in the Figures, and no place else. By positioning the constraints on either side of the front of the trigger guard, the casing cannot be moved from vertical orientation when struck since otherwise the attachment to the rail might not be sufficient to prevent problems with both steadiness and camera movement relative to the gun barrel. It also prevents interference with the trigger position at the bottom of the trigger guard. This represents a huge improvement in attachment of a camera in terms of stability and safeguard. In addition, having constraint only on the front of the trigger guard means the constraints will not interfere with gun use.

As used herein, the term “Hall effect sensor or a magnetic reed switch” refers to a transducer that varies its output voltage in response to a magnetic field. Hall effect sensor or a magnetic reed switch is used for proximity switching of the camera on and off when a magnet is placed in the holster at the appropriate position. In one embodiment, the system records the gauss strength of the magnet utilized so that one can tell if the magnet in the holster was utilized to turn on or off the camera or some other magnet of different gauss strength. Other sensors (e.g., reed switch and similar) can be used as well to activate the camera upon removal from the holster or the like.

As used herein, the term “microcontroller” refers to a computer present in a single integrated circuit which is dedicated to perform limited task and application. For example, coordinating the recording, fault protection, coordinating the Hall effect sensor or a magnetic reed switch, coordinating sending the video over Wi-Fi, cellular (e.g. LTE chip), Internet, or Bluetooth, and the like, as needed. The microcontroller functionality can also be embedded within the camera recording device though the transmitter may be separate from the microcontroller.

As used herein, the term “sent wirelessly” refers to having a wireless transmitter in the camera system which can take the video from the camera in the housing and send it to a remote third location for processing in a manner to prevent tampering with the video. For example, the system could automatically open an incident report file and place the video taken by the camera in that file thus automatically creating the file necessary for reporting a particular incident by the officer having the gun drawn from the holster. In one embodiment, there is software in the case that encrypts the video as recorded and/or played back.

Optional attachments include a light or light guide, a power output, and the like powered by the camera power source. Lights can be LED, night vision, or the like.

In one embodiment, the system is connected to the firing of the gun such that the gun cannot be fired unless the camera is operating. This would require the officer to keep the camera charged and prevent the system from not working by just not charging the battery.

### DRAWINGS

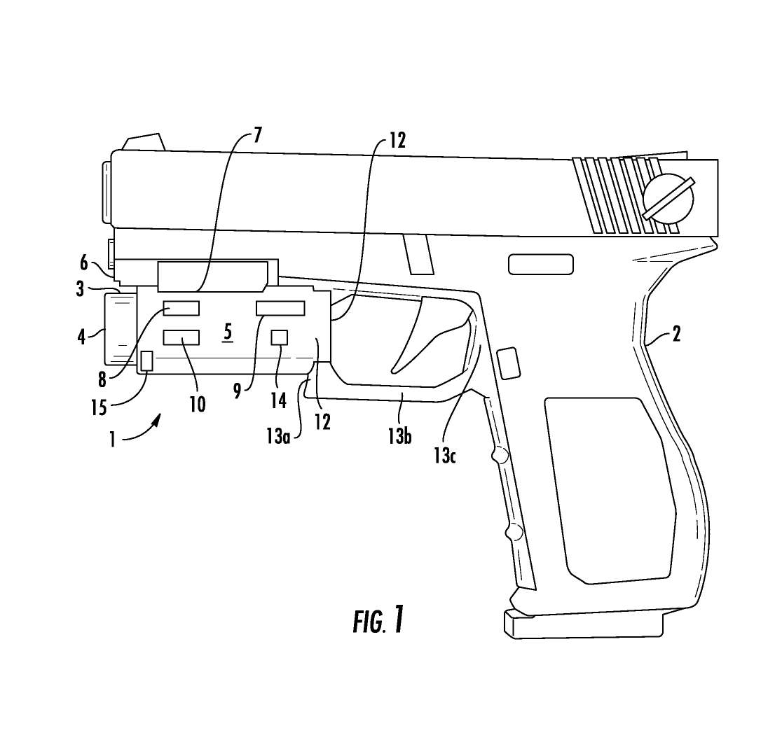

Now referring to the drawings, FIG. 1 is a side view of the camera system 1 mounted on a handgun 2. While one gun type is drawn, others could be substituted. In this view, video camera 3 having lens 4 protruding from the tamper evident case 5 is shown. The tamper evident case 5 is mounted to the Weaver/Picatinny rail 6 of handgun 2 by mounting bracket 7 which is set-screwed in place on the rail and permanently affixed to the case. While any tamper evident device can be used, shown is tamper evident seal 15. Inside the case is Hall effect sensor or a magnetic reed switch 8 for turning the camera on and off, battery 9, and memory device 10 which include a memory card and a recording device as described above. The case 5 has a wing constraint 12 on either side of the front of the trigger guard 13a (and not the bottom 13b or back 13c) to stabilize and brace the camera against misalignment, use interference, and other issues. Other devices 14 include Wi-Fi/Bluetooth/cellular/Internet/etc. for sending video to a different location such as an incident case file, a device for measuring and recording gauss strength of the magnet used to turn the device on or off, a device for preventing the handgun from firing unless the camera is operating, microcontroller, and the like.

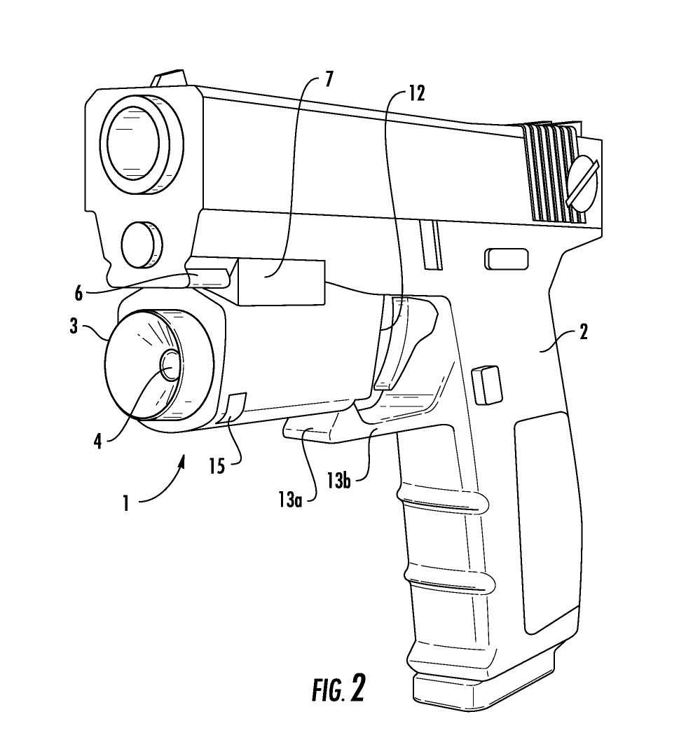

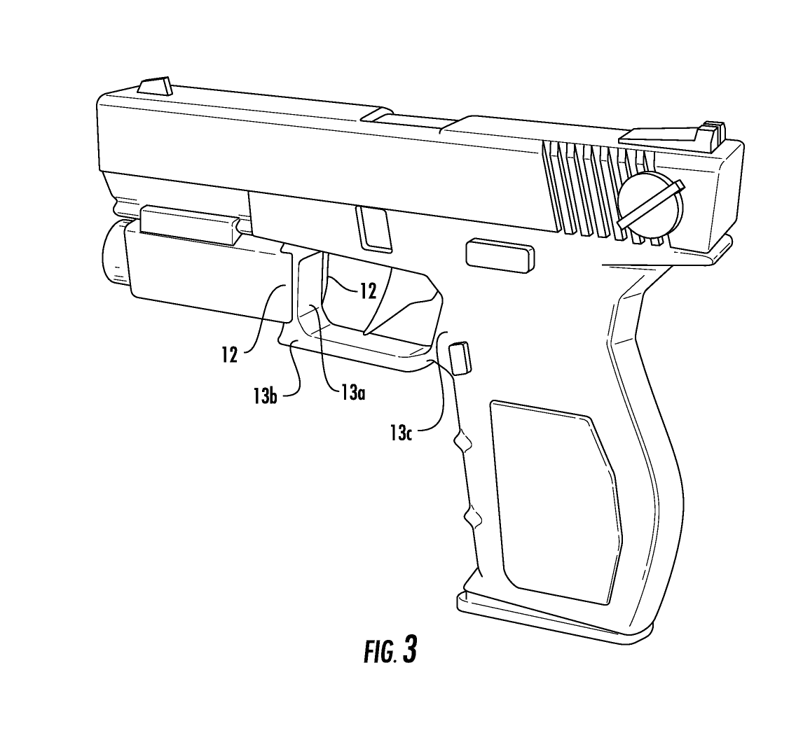

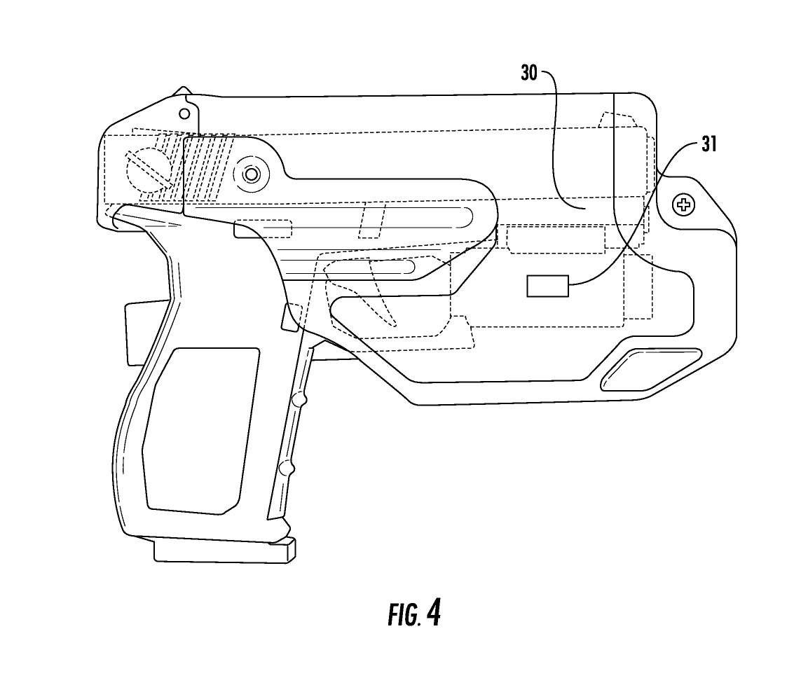

FIG. 2 is a perspective view of the camera system 1. This shows the same features but some are clearer in this view than in a side view. FIG. 3 is a different perspective view of the camera system. FIG. 4 is a side view of the camera system and handgun positioned in a tactical holster 30. In this view, camera in system 1 hidden from view is nestled next to magnet 31 of a selected gauss strength mounted in holster to trigger a Hall effect sensor or a magnetic reed switch when the handgun is removed.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A self-contained tamper evident video camera system for use on a tactical gun with a trigger guard having a front, bottom, and back and stored in a tactical holster wherein the gun is designed for use in tactical situations, the self-contained video camera system consisting of:
a) a video camera;
b) a mounting bracket which removably attaches the video camera system to the tactical gun;
c) a single on and off switch for the camera consisting of a Hall effect sensor or a magnetic reed switch in the video camera system and a magnet on the holster;
d) a battery to power the video camera;
e) a recordable medium in the self-contained video camera system for recording video wherein a recorded video on the recordable medium can be accessed by at least one of the group consisting of a video download port and a wireless transmitter;
f) wherein the video camera, the switch, the battery, the wireless transmitter, and the recordable medium are contained in a tamper evident case, which is constructed to be positioned with wing constraints at the rear of the case which are positioned on either side of only the front of the trigger guard and positioned against the trigger guard to brace the housing from moving left or right; and
g) wherein the video camera system has at least one feature selected from the group consisting of a microcontroller, a light guide, a light, a gauss strength measuring device, a power output, a charging port, a system that prevents firing of the gun unless the camera is operating, encryption software, and night vision for the camera.

2. The self-contained video camera system according to claim 1 wherein the tamper evident case is sized such that when the video camera system is mounted on a handgun, the handgun fits in a tactical holster designed for a handgun flashlight attached to a Weaver/Picatinny rail.

3. The self-contained video camera system according to claim 1 wherein the mounting bracket is permanently affixed to the tamper evident case.

4. The self-contained video camera system according to claim 1 wherein the mounting bracket attaches to a Weaver/Picatinny rail on the tactical gun.

5. The self-contained video camera system according to claim 1 wherein the wireless transmitter is a cellphone transmitter.

6. The self-contained video camera system according to claim 1 wherein the wireless transmitter is a Bluetooth transmitter.

7. The self-contained video camera system according to claim 1 wherein the wireless transmitter is connected to the Internet.

8. The self-contained video camera system according to claim 1 wherein the tamper evident case has detectable entry features.

9. The self-contained video camera system according to claim 8 wherein the tamper evident feature is selected from one or more of the group consisting of seals, break off or specialized screws, color change strips, and required specialized tools.
